(19) United States
(12) Patent Application Publication
(10) Pub. No.: US 2003/0099750 A1
(43) Pub. Date: May 29, 2003

(54) Process for producing baked breading flour product and baked breading flour product

(76) Inventor: Dirk Meininghaus, Ahlen (DE)

Correspondence Address: LERNER AND GREENBERG P.A., Post Office Box 2480, Hollywood, FL, 33022-2480, US

(21) Appl. No.: 10/106,144

(22) Filed: Mar. 26, 2002

(30) Foreign Application Priority Data
Nov. 26, 2001 (DE) 101 57 608.0

(51) Int. Cl. A21D 10/00

(52) U.S. Cl. 426/549

(57) ABSTRACT

A process for producing a baked breading flour product includes the first step of baking breading flour with added sugar, mixing vegetable fat with the breading flour-sugar baked mixture to form an intermediate product, and then roasting the intermediate product. A baked breading flour product includes a mixture of breading flour and sugar baked together forming a baked mixture, and a mixture of vegetable fat and the baked mixture forming an intermediate product, the intermediate product being roasted and having a reddish-brown coloration characteristic of frying.

### BACKGROUND OF THE INVENTION

1. Field of the Invention

The invention relates to a process for producing a baked breading flour product and a baked breading flour product produced by the process.

The process and the breading flour product produced by the process are not in the prior art. Products that can be baked in an oven have been precooked to date by deep-fat frying in a fat bath at temperatures of approximately 160° C. to 170° C. and, as a result, have a fat content of approximately 15%, measured in the coating. The products thus treated can only be baked in an oven as a result of the fat content because a “dry” outer coating could not assume the desired function. This is because the breading flour requires a mediator to conduct further the heat acting on the product to ensure complete cooking in the baking oven. In addition, the open structure of the breading flour must be encapsulated against a baking oven off-taste that typically occurs and has an adverse effect on the product. The encapsulation is primarily to be achieved with fat that penetrates the porous breading flour structure and fulfills the above-described functions. In addition, the fat prevents burning of the dry product, especially in an edge region.

A disadvantage of these prior art processes is the overall high energy consumption for the production of products treated with breading flour, which is required for the deep-fat frying and for the exhaust air cleanup and subsequent cooling to the starting temperature. In particular, procurement and maintenance of the deep-fat fryers, together with running costs for fat, disposal of the waste fat, and the necessary exhaust air combustion systems, which must be operated with high energy consumption and constant servicing or maintenance, are extremely cost-intensive, so that, together with costs for cooling, up to 15 to 20% of increased production costs are reached. The cooking loss due to deep-fat frying and cooling is further approximately 10% of the starting product, depending on the temperature and cooking time chosen. The product treated with such prior art breading flour, in order to obtain a reddish-brown coloring characteristic of frying, must then be pre-baked, which requires further usage of energy.

### SUMMARY OF THE INVENTION

It is accordingly an object of the invention to provide a process for producing a baked breading flour product and a baked breading flour product produced by the process that overcomes the hereinafore-mentioned disadvantages of the heretofore-known devices and methods of this general type and that is considerably more economical to carry out, and that offers a baked breading flour product prepared considerably more conveniently by the end user.

With the foregoing and other objects in view, there is provided, in accordance with the invention, a process for producing a baked breading flour product including the steps of baking breading flour with sugar to form a baked mixture, subsequently mixing vegetable fat with the baked mixture to form an intermediate product, and roasting the intermediate product to produce a reddish-brown coloration characteristic of frying.

By mixing the breading flour with sugar in a first process step and baking it, then, in a second process step adding vegetable fat and mixing it therewith, and in a following third process step roasting it, a baked breading flour product is provided that, as a result of the sugar content, obtains the desired reddish-brown coloration characteristic of frying, so that a product treated therewith can be baked immediately in the actual cooking process to give the finished product by large-scale consumers such as restaurants, snack stands, large-scale kitchens, catering enterprises, or airlines. As a result, a second heating of a product can be avoided.

Advantageously, products treated with the breading flour according to the invention can be baked to give the finished product in convection baking ovens, as are increasingly being used in more and more catering enterprises. Furthermore, the considerably decreased fat content in the baked breading flour product is of particular advantage, compared with the coating of a deep-fat fried product, so that healthier nutrition results from use of the product of the invention. In addition, the strong odor nuisance, and also fouling of pans and deep-fat fryers is entirely avoided because these are no longer required.

In accordance with another mode of the invention, the reddish-brown coloration is produced because of the presence of the sugar.

In accordance with a further mode of the invention, the breading flour is extra dry breading flour.

In accordance with an added mode of the invention, an amount of the sugar in the baking step is between 2 and 6 percent by weight of the amount of the breading flour, preferably, approximately 4 percent by weight of the amount of the breading flour.

In accordance with an additional mode of the invention, the baking step is carried out for between 25 and 50 minutes at between 215° C. to 245° C., preferably, for 40 minutes at 230° C.

In accordance with yet another mode of the invention, an amount of the vegetable fat added in the mixing step is between 14 and 23 percent by weight of the baked mixture, preferably, 17 percent by weight of the baked mixture.

In accordance with yet a further mode of the invention, the roasting step is carried out in a continuous-flow drying system.

In accordance with yet an added mode of the invention, the roasting step is carried out for between 10 and 30 minutes at between 140° C. and 180° C., preferably, for 20 minutes at 160° C.

With the objects of the invention in view, there is also provided a process for producing a baked breading flour product including the steps of baking breading flour with sugar to form a baked mixture, subsequently mixing vegetable fat with the baked mixture to form an intermediate product, and roasting the intermediate product for between 10 and 30 minutes at between 140° C. and 180° C.

With the objects of the invention in view, there is also provided a process for producing a baked breading flour product including the steps of baking breading flour with sugar to form a baked mixture, the sugar content being between 2 and 6 percent by weight of the amount of the breading flour, subsequently mixing vegetable fat with the baked mixture to form an intermediate product, and roasting the intermediate product for between 10 and 30 minutes at between 140° and 180° C.

With the objects of the invention in view, there is also provided a process for producing a baked breading flour product including the steps of baking breading flour with sugar for between 25 and 50 minutes at between 215° C. and 245° C. to form a baked mixture, subsequently mixing vegetable fat with the baked mixture to form an intermediate product, and roasting the intermediate product for between 10 and 30 minutes at between 140° C. and 180° C.

With the objects of the invention in view, there is also provided a process for producing a baked breading flour product including the steps of baking breading flour with sugar to form a baked mixture, subsequently mixing vegetable fat with the baked mixture to form an intermediate product, the vegetable fat content being between 14 and 23 percent by weight of the baked mixture, and roasting the intermediate product for between 10 and 30 minutes at between 140° C. and 180° C.

With the objects of the invention in view, there is also provided a baked breading flour product including a mixture of breading flour and sugar baked together forming a baked mixture and a mixture of vegetable fat and the baked mixture forming an intermediate product, the intermediate product being roasted and having a reddish-brown coloration characteristic of frying.

With the objects of the invention in view, there is also provided a baked breading flour product including a mixture of breading flour and sugar baked together forming a baked mixture and a mixture of vegetable fat and the baked mixture forming an intermediate product, the intermediate product being roasted for between 10 and 30 minutes at between 140° C. and 180° C.

With the objects of the invention in view, there is also provided a baked breading flour product including a mixture of breading flour and sugar baked together forming a baked mixture, the sugar being between 2 and 6 percent by weight of the breading flour and a mixture of vegetable fat and the baked mixture forming an intermediate product, the intermediate product being roasted for between 10 and 30 minutes at between 140° C. and 180° C.

With the objects of the invention in view, there is also provided a baked breading flour product including a mixture of breading flour and sugar baked together for between 25 and 50 minutes at between 215° C. and 245° C. forming a baked mixture and a mixture of vegetable fat and the baked mixture forming an intermediate product, the intermediate product being roasted for between 10 and 30 minutes at between 140° C. and 180° C.

With the objects of the invention in view, there is also provided a baked breading flour product including a mixture of breading flour and sugar baked together forming a baked mixture and a mixture of vegetable fat and the baked mixture forming an intermediate product, the vegetable fat being between 14 and 23 percent by weight of the baked mixture, the intermediate product being roasted for between 10 and 30 minutes at between 140° C. and 180° C.

Other features that are considered as characteristic for the invention are set forth in the appended claims.

Although the invention is described herein as embodied in a process for producing a baked breading flour product and the baked breading flour product produced by the process, it is, nevertheless, not intended to be limited to the details described because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments.

### DESCRIPTION OF THE PREFERRED EMBODIMENTS

To ensure that the added sugar does not form lumps with the breading flour, preferably, the starting material used for the baking oven breading flour is extra dry breading flour. The amount of sugar added can be between 2 and 6%, in particular, 4%, of the starting amount of the breading flour. The first process step in which the breading flour is baked with the added sugar advantageously lasts between 25 and 50 minutes at a temperature between 215° C. and 245° C., in particular, in the case of the use of an extra dry breading flour, for 40 minutes at 230° C.

The amount of vegetable fat added is, for a breading flour to be produced in a preferred manner, between 14 and 25 percent by weight, in particular, 17 percent by weight, of the starting amount of baked breading flour-sugar mixture.

The roasting operation in the third process step is performed according to the invention in a continuous-flow drying system, and is performed over a period of 10 to 30 minutes at a temperature between 140° C. and 180° C., in particular, for 20 minutes at 160° C.

I claim:

1. A process for producing a baked breading flour product, which comprises:
baking breading flour with sugar to form a baked mixture;
subsequently mixing vegetable fat with the baked mixture to form an intermediate product; and
roasting the intermediate product to produce a reddish-brown coloration characteristic of frying.

2. The process according to claim 1, which further comprises producing the reddish-brown coloration because of the presence of the sugar.

3. The process according to claim 1, wherein the breading flour is extra dry breading flour.

4. The process according to claim 1, wherein an amount of the sugar in the baking step is between 2 and 6 percent by weight of the amount of the breading flour.

5. The process according to claim 1, wherein an amount of the sugar in the baking step is approximately 4 percent by weight of the amount of the breading flour.

6. The process according to claim 1, which further comprises carrying out the baking step for between 25 and 50 minutes at between 215° C. to 245° C.

7. The process according to claim 1, which further comprises carrying out the baking step for 40 minutes at 230° C.

8. The process according to claim 1, wherein an amount of the vegetable fat added in the mixing step is between 14 and 23 percent by weight of the baked mixture.

9. The process according to claim 1, wherein an amount of the vegetable fat added in the mixing step is 17 percent by weight of the baked mixture.

10. The process according to claim 1, which further comprises carrying out the roasting step in a continuous-flow drying system.

11. The process according to claim 1, which further comprises carrying out the roasting step for between 10 and 30 minutes at between 140° C. and 180° C.

12. The process according to claim 1, which further comprises carrying out the roasting step for 20 minutes at 160° C.

13. A process for producing a baked breading flour product, which comprises:
baking breading flour with sugar to form a baked mixture;
subsequently mixing vegetable fat with the baked mixture to form an intermediate product; and
roasting the intermediate product for between 10 and 30 minutes at between 140° C. and 180° C.

14. A process for producing a baked breading flour product, which comprises:
baking breading flour with sugar to form a baked mixture, the sugar content being between 2 and 6 percent by weight of the amount of the breading flour;
subsequently mixing vegetable fat with the baked mixture to form an intermediate product; and
roasting the intermediate product for between 10 and 30 minutes at between 140° C. and 180° C.

15. A process for producing a baked breading flour product, which comprises:
baking breading flour with sugar for between 25 and 50 minutes at between 215° C. and 245° C. to form a baked mixture;
subsequently mixing vegetable fat with the baked mixture to form an intermediate product; and
roasting the intermediate product for between 10 and 30 minutes at between 140° C. and 180° C.

16. A process for producing a baked breading flour product, which comprises:
baking breading flour with sugar to form a baked mixture;
subsequently mixing vegetable fat with the baked mixture to form an intermediate product, the vegetable fat content being between 14 and 23 percent by weight of the baked mixture; and
roasting the intermediate product for between 10 and 30 minutes at between 140° C. and 180° C.

17. A baked breading flour product, comprising:
a mixture of breading flour and sugar baked together forming a baked mixture; and
a mixture of vegetable fat and said baked mixture forming an intermediate product, said intermediate product being roasted and having a reddish-brown coloration characteristic of frying.

18. The flour according to claim 17, wherein said breading flour is extra dry breading flour.

19. The flour according to claim 17, wherein said sugar is between 2 and 6 percent by weight of said breading flour.

20. The flour according to claim 17, wherein said sugar is approximately 4 percent by weight of said breading flour.

21. The flour according to claim 17, wherein said mixture is baked for between 25 and 50 minutes at between 215° C. and 245° C.

22. The flour according to claim 17, wherein said mixture is baked for 40 minutes at 230° C.

23. The flour according to claim 17, wherein said vegetable fat is between 14 and 23 percent by weight of said baked mixture.

24. The flour according to claim 17, wherein said vegetable fat is 17 percent by weight of said baked mixture.

25. The flour according to claim 17, wherein said intermediate product is roasted for between 10 and 30 minutes at between 140° C. and 180° C.

26. The flour according to claim 17, wherein said intermediate product is roasted for 20 minutes at 160° C.

27. A baked breading flour product, comprising:
a mixture of breading flour and sugar baked together forming a baked mixture; and
a mixture of vegetable fat and said baked mixture forming an intermediate product, said intermediate product being roasted for between 10 and 30 minutes at between 140° C. and 180° C.

28. A baked breading flour product, which comprises:
a mixture of breading flour and sugar baked together forming a baked mixture, said sugar being between 2 and 6 percent by weight of said breading flour; and
a mixture of vegetable fat and said baked mixture forming an intermediate product, said intermediate product being roasted for between 10 and 30 minutes at between 140° C. and 180° C.

29. A baked breading flour product, which comprises:
a mixture of breading flour and sugar baked together for between 25 and 50 minutes at between 215° C. and 245° C. forming a baked mixture; and
a mixture of vegetable fat and said baked mixture forming an intermediate product, said intermediate product being roasted for between 10 and 30 minutes at between 140° C. and 180° C.

30. A baked breading flour product, which comprises:
a mixture of breading flour and sugar baked together forming a baked mixture; and
a mixture of vegetable fat and said baked mixture forming an intermediate product, said vegetable fat being between 14 and 23 percent by weight of said baked mixture, said intermediate product being roasted for between 10 and 30 minutes at between 140° C. and 180° C.
